(19) United States
(12) Patent Application Publication
(10) Pub. No.: US 2006/0176978 A1
(43) Pub. Date: Aug. 10, 2006

(54) FSK signal generator

(76) Inventor: Kazuo Kawai, Tokyo (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/202,123

(22) Filed: Aug. 11, 2005

(30) Foreign Application Priority Data
Feb. 10, 2005 (JP) 2005-034506

(51) Int. Cl. H04L 27/12

(52) U.S. Cl. 375/303

(57) ABSTRACT

An FSK signal generator includes a first clock generator which generates a first clock pulse having a frequency n·f1, a second clock generator which generates a second clock pulse having a frequency n·f2, a switch which serves so as to output the first or second clock pulse in accordance with input data codes, a counter which outputs each address code according to the count of the outputted clock pulse, a read-only memory in which coded values of respective sampling points of a signal waveform lying in one cycle are written in address order and from which the coded values of the respective sampling points are read in response to the address codes of the counter, a digital/analog converter which converts the read coded values into an analog signal, and a low-pass filter which smoothes the analog signal to form an FSK signal.

### RELATED/PRIORITY APPLICATION

This application claims priority with respect to Japanese Application No. 2005-034506, which was filed on Feb. 10, 2005, and is incorporated herein by reference in its entirety.

### BACKGROUND OF THE INVENTION

1. Field of the Invention

The present invention relates to an FSK signal generator, and particularly to an FSK signal generator which generates an FSK (Frequency Shift Keying) signal continuous in phase upon frequency shifting in a low frequency band like an audio frequency band.

2. Description of the Related Art

In general, an FSK signal is of a frequency-modulated signal set so as to reach different first and second frequencies F1 and F2 in response to codes 0 and 1 of an input binary data signal and set so as to be frequency-shifted between the first and second frequencies F1 and F2 in response to changes in the codes of the binary data signal. When the FSK signal is frequency-shifted from the first frequency F1 to the second frequency F2 or frequency-shifted from the second frequency F2 to the first frequency F1, the waveform of the resultant FSK signal is temporarily brought to an improper or disordered state upon its frequency shifting unless the phase of the FSK signal is in a continuous state. With its state, the occupied bandwidth of the FSK signal becomes wider than the original occupied bandwidth. Therefore, a voltage-controlled oscillator (VCO) is normally used upon generation of the FSK signal, and an oscillation signal of the voltage-controlled oscillator is frequency-modulated by the binary data signal to obtain the corresponding FSK signal.

As a modulation index expressed by the ratio (shift width/data rate) between the shift width and the data rate becomes small, the FSK signal can be narrowed in occupied bandwidth. When the modulation index is 0.5, the occupied bandwidth of the FSK signal becomes the smallest. Such an FSK system that the corresponding signal is selected and frequency-modulated such that such a modulation index is reached, is particularly called “MSK (Minimum Shift Keying) system”.

Generally, ones lying in a frequency band so higher than an audio frequency band are heavily used for the FSK signal as its frequency band. According to purposes, an FSK signal lying in a low frequency band like the audio frequency band might also be used.

When the FSK signal lying in such a low frequency band is generated using the voltage controlled oscillator, its oscillation frequency becomes low. Therefore, an inductance element L and a capacitance element C of a resonant circuit used in the voltage controlled oscillator result in ones having high reactance values respectively. When the inductance element L and the capacitance element C each having such a high reactance value are used, the occupied capacities of those elements L and C are considerably increased and hence a disadvantage occurs upon mounting of the voltage controlled oscillator.

In order to avoid such a mounting disadvantage of the voltage controlled oscillator, the following two means have heretofore been used. The first means corresponds to a means wherein such a voltage controlled oscillator as to generate an FSK signal lying in a frequency band considerably higher than an FSK signal lying in a low frequency band intended to obtain or to try for is used as the voltage controlled oscillator, the FSK signal lying in the resultant high frequency band is reduced to the low frequency band to try for by frequency conversion, whereby a required FSK signal is obtained. The second means is of a means wherein an equation-based digital computing process is performed using a digital signal processor (DSP) to form a digital signal and the resultant digital signal is digital-analog converted to obtain a required FSK signal.

Meanwhile, there is known an MSK system wherein as specific examples of the characteristics of the FSK signal lying in the low frequency band corresponding to the audio frequency band, the rate of data is 1200 bps, a frequency-shifted first frequency F1 is 1200 Hz, and a second frequency F2 is 1800 Hz. In this type of MSK system, the first frequency F1 is put or inserted just one cycle and the second frequency F2 is inserted 1.5 cycles during one bit of the data. Therefore, when switching from the first frequency F1 to the second frequency F2 or the second frequency F2 to the first frequency F1 is made, its switching can be just made when the first frequency F1 and the second frequency F2 are in phase, if the first and second frequencies F1 and F2 are phase-synchronized. It is therefore possible to prevent spreading of a frequency spectrum due to phase discontinuity.

As means for implementing such an MSK system, the applicant of the present application has previously applied for the patent as Japanese Patent Application No. 2005-022587 that discloses an FSK signal generator wherein an impulse-like sharply-waveformed clock pulse of 600 pps corresponding to a rate equal to ½ of a baud number of data is formed and a first band-pass filter with a frequency 1200 Hz as a center pass frequency and a second band-pass filter with a frequency 1800 Hz as a center pass frequency are driven by the clock pulse to thereby generate phase-synchronized fist and second carrier signals therefrom respectively for each time of the occurrence of the clock pulse, and wherein the first carrier signal and the second carrier signal are respectively phase-inverted to form a phase-inverted first carrier signal and a phase-inverted second carrier signal together with the first carrier signal and the second carrier signal, and these four carrier signals are applied to a carrier signal selection circuit constituted of four controllable switches and one of the controllable switches in the carrier signal selection circuit is selected according to a combination of three states: codes 0 and 1 of input data, states 1 (+1) and 0 (−1) at the completion of the immediately preceding transmit carrier signals, and states 1 and 0 in the neighborhood of the clock pulse whose transmit timing is 600 pps, whereby the waveforms of respective parts of the four carrier signals are cut out in such a manner that the phase of an output FSK signal is made continuous, and the cut partial waveforms are sequentially combined together to thereby form the intended FSK signal continuous in phase.

However, the FSK signal generator having applied for the patent previously can be configured because the respective frequencies of the first carrier signal F1 and the second carrier signal F2 have a simple multiple relationship in which they are equal to 1.0 times the rate of the data and 1.5 times the data rate. Thus, when the respective frequencies of the first carrier signal F1 and the second carrier signal F2 have no such a simple multiple relationship, e.g., when the frequency of the first carrier signal is 1300 Hz and the frequency of the second carrier signal is 1900 Hz, a simple multiple relationship with respect to the data rate 1200 bps is not established even in the case of the FSK signal generator using the same MSK system. Therefore, the FSK signal generator having applied for the patent previously cannot be utilized, and there is no other effective means using the aforementioned conventional first means or second means.

### SUMMARY OF THE INVENTION

The present invention has been made in view of such a background art. It is therefore an object of the present invention to provide an FSK signal generator capable of generating an FSK signal continuous in phase, lying in a low frequency band in a simple circuit configuration based on only normal parts regardless of whether it being an MSK system, without using large-sized inductance and capacitance elements each having a high reactance value, a digital signal processor and a frequency converting means.

In order to attain the above object, there is provided an FSK signal generator according to the present invention, which generates an FSK signal lying in a low frequency band, frequency-shifted to a first frequency f and a second frequency f2 in response to input data codes, comprising a first configuration having a first clock generator which generates a first clock pulse having a frequency n·f1 equal to an integral n times the first frequency f1, a second clock generator which generates a second clock pulse having a frequency n·f2 equal to the integral n times the second frequency f2, a selector switch switched by the input data codes to select and output the first clock pulse generated from the first clock generator and the second clock pulse generated from the second clock generator, an address counter which outputs each address code according to a count of the selected and outputted clock pulse, a read-only memory in which coded values of respective sampling points, obtained by sampling a sine waveform or a cosine waveform lying within one cycle at an n times rate are written in address order and from which each of the coded values of the respective sampling points is read in response to the address code of the address counter, a digital/analog converter which digital/analog-converts the coded values read from the read-only memory and outputs the digital/analog-converted analog signal, and a low-pass filter which smoothes the analog signal to form an FSK signal.

Also in order to attain the above object, there is provided an FSK signal generator according to the present invention, which generates an FSK signal lying in a low frequency band, frequency-shifted to a first frequency f1 and a second frequency f2 in response to input data codes, comprising a second configuration including a first clock generator which generates a first clock pulse having a frequency n·m·f1 equal to respective integral n and m times the first frequency f1, a second clock generator which generates a second clock pulse having a frequency n·m·f2 equal to the respective integral n and m times the second frequency f2, a selector switch switched by the input data codes to select and output the first clock pulse generated from the first clock generator and the second clock pulse generated from the second clock generator, a digital divider which outputs m-divided clock pulses of the selected and outputted clock pulse, an address counter which outputs address codes according to counts of the m-divided clock pulses, a read-only memory in which coded values of respective sampling points, obtained by sampling a sine waveform or a cosine waveform lying within one cycle at an n times rate are written in address order and from which each of the coded values of the respective sampling points is read in response to the address code of the address counter, a digital/analog converter which digital/analog-converts each coded value read from the read-only memory and outputs the digital/analog-converted analog signal, and a low-pass filter which smoothes the analog signal to form an FSK signal.

Further, in order to attain the above object, there is provided an FSK signal generator which generates an FSK signal lying in a low frequency band, frequency-shifted to a first frequency f1 and a second frequency f2 in response to input data codes, comprising a third configuration having a first clock generator which generates a first clock pulse having a frequency n·f1 equal to an integral n times the first frequency f1, a second clock generator which generates a second clock pulse having a frequency n·f2 equal to the integral n times the second frequency f2, a selector switch switched by the input data codes to select and output the first clock pulse generated from the first clock generator and the second clock pulse generated from the second clock generator, a first low-pass filter which averages a variation in the phase of the selected and outputted clock pulse, a Schmitt trigger which waveform-shapes the clock pulse outputted from the first low-pass filter, an address counter which outputs each address code according to a count of the waveform-shaped clock pulse, a read-only memory in which coded values of respective sampling points, obtained by sampling a sine waveform or a cosine waveform lying within one cycle at an n times rate are written in address order and from which each of the coded values of the respective sampling points is read in response to the address code of the address counter, a digital/analog converter which digital/analog-converts each coded value read from the read-only memory and outputs the digital/analog-converted analog signal, and a second low-pass filter which smoothes the analog signal to form an FSK signal.

In the first through third configurations, the read-only memory can be set to a configuration wherein one cycle of the sine or cosine waveform has been written therein.

Also, in the first through third configurations, the read-only memory can be set to a configuration wherein a ½ cycle of the sine or cosine waveform has been written therein.

Further, in the first through third configurations, the read-only memory can be set to a configuration wherein a ¼ cycle of the sine or cosine waveform has been written therein.

According to the first through third configurations as described above, when frequency shifting corresponding to input data codes is performed to generate an FSK signal lying in a low frequency band, a first clock generator or a second clock generator is selected corresponding to the input data codes. A clock pulse outputted from the selected clock generator is added to an address counter. Coded values of respective sampling points, which are obtained by sampling a sine or cosine waveform lying in one cycle at an n times rate, and which are written in a read-only memory, are read in address order according to address codes outputted from the address counter. The read coded values are converted into an analog signal, whereby an output FSK signal having a continuous phase can be generated. Thus, advantageous effects can be brought about in that a stable FSK signal can be generated regardless of an MSK system by simply using a simple circuit configuration constituted of normal components on the whole, and there is no need to perform overall frequency conversion and digital processing using a digital signal processor, an inexpensive and small-sized FSK signal generator can be obtained without using various additional circuits such as a local carrier wave generating circuit, a band-pass filter, etc., and expensive devices such as the digital signal processor, etc.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 relates to a first embodiment of an FSK signal generator according to the present invention and is a block diagram showing its fragmentary circuit configuration;

FIG. 2 relates to a second embodiment of an FSK signal generator according to the present invention and is a block diagram showing its fragmentary circuit configuration;

FIG. 3 relates to a third embodiment of an FSK signal generator according to the present invention and is a block diagram showing its fragmentary circuit configuration; and

FIG. 4 relates to a fourth embodiment of an FSK signal generator according to the present invention and is a block diagram showing its fragmentary circuit configuration.

### DETAILED DESCRIPTION OF THE PREFERRED EMBODIMENTS

Preferred embodiments of the present invention will hereinafter be explained with reference to the accompanying drawings.

### First Preferred Embodiment

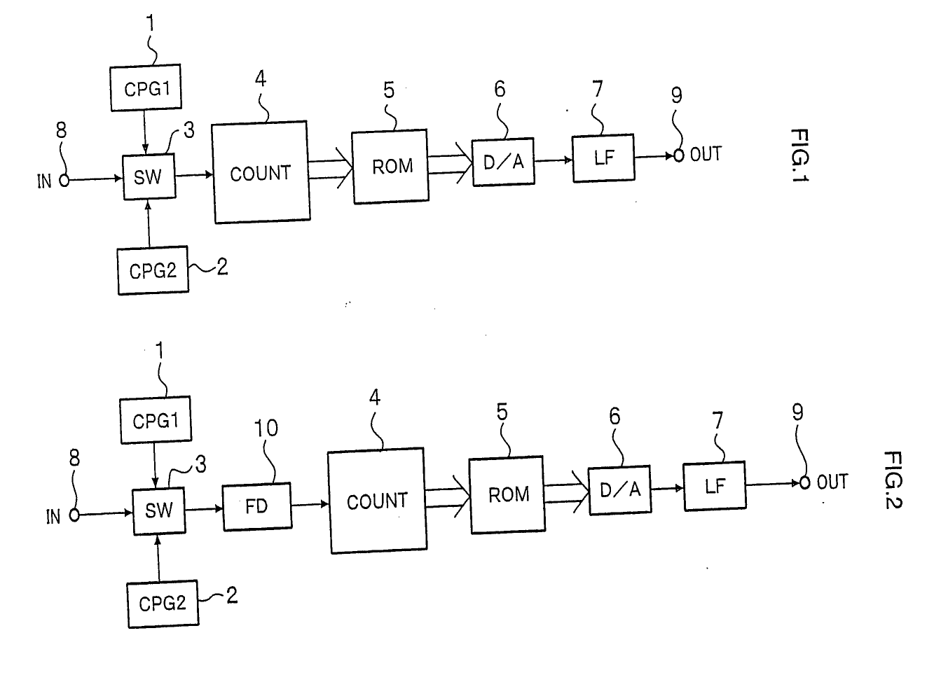

FIG. 1 relates to a first embodiment of an FSK signal generator according to the present invention and is a block diagram showing its fragmentary circuit configuration.

As shown in FIG. 1, the FSK signal generator according to the first embodiment includes a first clock pulse generator (CPG1) 1, a second clock pulse generator (CPG2) 2, a selector switch (SW) 3, an address counter (COUNT) 4, a read-only memory (ROM) 5, a digital/analog converter (D/A) 6, a low-pass filter (LF) 7, a data input terminal (IN) 8, and an FSK signal output terminal (OUT) 9. Incidentally, although codes consisting of n and m appear in every place as in, for example, a scale-of-n counter in the following description, these codes n and m are respectively arbitrary integers excluding 0 and 1 and their values can suitably be selected and set.

In this case, the selector switch 3 is provided with a first input terminal, a second input terminal, an output terminal and a control terminal. The control terminal is electrically connected to the data input terminal 8, the first input terminal is electrically connected to an output terminal of the first clock pulse generator 1, the second input terminal is electrically connected to an output terminal of the second clock pulse generator 2, and the output terminal is electrically connected to an input terminal of the address counter 4. The address counter 4 is of, for example, a binary counter and includes a plurality of output terminals. The plurality of output terminals are electrically parallel-connected to their corresponding plural input terminals of the read-only memory 5. The read-only memory 5 includes a plurality of output terminals together with the plurality of input terminals. The plurality of output terminals thereof are electrically connected in shunt with their corresponding plural input terminals of the digital/analog converter 6. The digital/analog converter 6 has an output terminal electrically connected to an input terminal of the low-pass filter 7. The low-pass filter 7 has an output terminal electrically connected to the FSK signal output terminal 9.

The operation of the FSK signal generator configured as mentioned above is as follows:

The first clock pulse generator 1 generates an impulse-like first clock pulse having a frequency n·f1 equal to n times the first frequency f1. The second clock pulse generator 2 generates an impulse-shaped second clock pulse having a frequency n·f2 equal to n times the second frequency f2. The selector switch 3 is switched corresponding to input data codes 0 and 1 supplied to the data input terminal 8. When the input data code 0 is taken, the selector switch 3 is switched so as to select and output the first clock pulse. When the input data code 1 is taken, the selector switch 3 is switched so as to select and output the second clock pulse. The address counter 4 is inputted with the output clock pulse selected by the selector switch 3, and counts the corresponding clock pulse and supplies its output to its corresponding address of the read-only memory 5 as an address input on a parallel basis.

The read-only memory 5 is configured as one wherein when sampling points of a sinusoidal or sine waveform or a cosine waveform corresponding to a 1 cycle are selected and formed in advance, amplitude values of the corresponding waveform at the respective sampling points are written therein according to digital coded values in address order. When the respective sampling points are addressed according to values counted by the address counter 4 supplied with clock pulses each having a predetermined speed or rate, their digital coded values are repeatedly read. The digital/analog converter 6 digital/analog-converts the digital coded values read from the read-only memory 5 and outputs an analog signal having a continuous signal waveform. The frequency of the analog signal changes depending upon the rate of reading of each digital coded value by the read-only memory 5. Upon obtaining an FSK signal, the read rate of each digital coded value of the read-only memory 5, i.e., the clock pulse for addressing the read-only memory 5 may be switched to the first clock pulse or the second clock pulse in such a manner that the frequency of the analog signal is shifted to the first frequency f1 or the second frequency f2.

Since the angular rate of the outputted FSK signal changes stepwise when the read rate of the read-only memory 5 is switched, a frequency spectrum of the FSK signal is naturally made wider than a normal one.

Therefore, the digital coded values read from the read-only memory 5 are converted into an analog signal by the digital/analog converter 6, followed by being smoothed through the low-pass filter 7. If such a low-pass filter 7 is used, then a process for interpolation between sampled values can be performed. Further, the enlarged frequency spectrum component is suppressed and the analog signal can be brought to its corresponding FSK signal continuous in waveform, whereby the spreading of the frequency spectrum of the FSK signal can be eliminated as a matter of course.

In this case, the sine or cosine waveform written into the read-only memory 5 may be selected in such a manner that one cycle thereof is written therein. However, the writing of one cycle of the waveform is not necessarily required. A ½ cycle thereof may be selected or a ¼ cycle thereof may be selected. And when the writing of the sine or cosine waveform corresponding to the ½ cycle or ¼ cycle into the read-only memory 5 is performed, the reading of each digital coded value from the read-only memory 5 is carried out upon its reading while traveling back and forth between an address 0 and the largest address where the corresponding waveform is being written, and there is a need to determine, depending on to which quadrant of the corresponding waveform the intended reading corresponds, whether the polarity of an outputted signal should be inverted.

Therefore, when the corresponding waveform is written into the read-only memory 5, there is a need to select either writing of the corresponding waveform corresponding to one cycle therein, writing of its ½ cycle or writing of its ¼ cycle. However, the writing of the waveform corresponding to the one cycle is most advantageous to the read-only memory 5 due to the reasons to be described below.

That is, when the writing of the corresponding waveform corresponding to one cycle into the read-only memory 5 is selected, the use of the address counter 4 and the read-only memory 5 alone is sufficient for a circuit configuration to be needed. However, when the writing of the waveform corresponding to the ½ or ¼ cycle therein is selected, there is a need to use two added circuits of a quadrant determination circuit and a polarity control circuit in addition to the use of the address counter 4 and the read-only memory 5. Thus, if the required address counter 4 and read-only memory 5 are not so large in circuit scale even though the writing of the corresponding waveform corresponding to one cycle into the read-only memory 5 is selected, there is then no need to use the quadrant determination circuit and the polarity control circuit necessary when the writing of its ½ or ¼ cycle into the read-only memory 5 is selected. Therefore, this becomes advantageous in configuration correspondingly.

Meanwhile, the address counter 4 and the read-only memory 5 employed in the FSK signal generator need to determine to which extent their circuit scales should be set. That is, when the number of sampling points of the read-only memory 5 is reduced and its sampling frequency is lowered where the digital coded values read from the read-only memory 5 are converted into the corresponding analog signal, it is not possible to represent a point of conversion from the data code 0 to the data code 1 or a point of conversion from the data code 1 to the data code 0 accurately in time, thereby leading to the occurrence of conversion-point jitters.

Therefore, there is a need to select the number of the sampling points of the read-only memory 5 in relatively large numbers and increase the sampling frequency thereof. If, for example, about 6% of a bit length is allowable as conversion-point jitters at this time, then the conversion-point jitters need to be represented using ones having 16 sampling points within one cycle, i.e., digital coded valued set every 22.5°=36°/16. This results in that the read-only memory 5 may have 16 addresses. It means that the address counter 4 may make use of a 4-bit counter. In contrast, a read-only memory (ROM) commercially available in practice commonly has addresses larger in number than the 16 addresses. A read-only memory (ROM) smaller that it in capacity is extremely low in price and easily available. Besides, one logic IC is enough to ensure a 4-bit counter. If these points are taken into consideration, then the writing of one cycle of the corresponding waveform into the read-only memory 5 is advantageous by the non-use of other extra circuits such as the quadrant determination circuit, the polarity control circuit, etc.

Assuming now that corresponding digital coded values of the sampling points of one cycle of the cosine waveform are written into the read-only memory 5, and sixteen addresses are selected and set within one cycle of the cosine waveform, the amplitude values of the cosine waveform are written into the sixteen addresses by the digital coded values over the addresses 0 to 15 every 22.5° as in the case of cos 0°, cos 22.5°, cos 45°, cos 67.5°, . . . . These digital coded values are sequentially read by the corresponding clock pulses supplied through the address counter 4.

Specific operations of the FSK signal generator will now be explained using the following specific numerical values. Now consider that in the present description, the rate of input data is 1200 bps, a first frequency F1 is 1300 Hz, a second frequency F2 is 1900 Hz and an integer number n is 16.

Input data applied from the data signal input terminal 8 is supplied to the selector switch 3. When the code of the input data is 0 at this time, the selector switch 3 is changed over to the first clock pulse generator 1. Thus, a first clock pulse of 20.8 (=1.3 kHz×16) kpps generated from the first clock pulse generator 1 is selected and outputted. When the code of the input data signal is 1, the selector switch 3 is switched to the second clock pulse generator 2, so that a second clock pulse of 30.4 (=1.9 kHz×16) kpps generated from the second clock pulse generator 2 is selected and outputted and supplied to the address counter 4. In this case, the address counter 4 is constituted of a binary 4-bit counter. Since a 4-bit output thereof reaches a maximum value “1111” and then becomes “0000”, the address counter 4 automatically operates as a ring counter. The 4-bit output determines a read address for the read-only memory 5. At this time, the read-only memory 5 reads the digital coded values of the cosine waveform written into the respective addresses and adds the read digital coded values to the digital/analog converter 6 where they are digital/analog-converted, after which they are outputted as an analog signal.

Since, at this time, the analog signal is frequency-shifted to the frequency 20.8 kHz corresponding to the first clock pulse or the frequency 30.4 kHz corresponding to the second clock pulse, there is a need to extract an FSK signal component of a frequency 1.3 kHz or a frequency 1.9 kHz from the analog signal. Therefore, the low-pass filter 7 is connected to a stage subsequent to the digital/analog converter 6. Then, the low-pass filter 7 extracts the FSK frequency component of the first frequency 1.3 kHz or the second frequency 1.9 kHz in the analog signal. As mentioned above, the low-pass filter 7 has the function of suppressing the conversion-point jitters and is hence capable of obtaining a predetermined FSK signal from the FSK signal output terminal 9.

Incidentally, there is no restraint on the time among three of an input data rate, a first clock pulse frequency outputted from the first clock pulse generator 1 and a second clock pulse frequency outputted from the second clock pulse generator 2 in the FSK signal generator according to the first embodiment. Therefore, when the selector switch 3 is changed over to effect a transition from the first clock pulse to the second clock pulse or vice versa, each pulse having a sharp waveform might be generated through the selector switch 3. When the pulse having the sharp waveform forms an FSK signal through the address counter 4, the read-only memory 5 and the digital/analog converter 6, a conversion-point jitter occurs in the FSK signal when the input data code is converted, regardless of the connection of the low-pass filter 7, so that the frequency spectrum of the FSK signal expands more than necessary. However, the spreading of the frequency spectrum of such an FSK signal can be suppressed by FSK signal generators according to second through fourth embodiments to be described below.

### Second Preferred Embodiment

Next, FIG. 2 relates to the second embodiment showing the FSK signal generator according to the present invention and is a block diagram showing its fragmentary circuit configuration. The second embodiment includes one means for suppressing the spreading of a frequency spectrum based on a conversion-point jitter produced upon conversion of an input data code.

The FSK signal generator (hereinafter called “second example circuit”) according to the second embodiment illustrated in FIG. 2 is different in configuration from the FSK signal generator (hereinafter called “first example circuit”) according to the first embodiment illustrated in FIG. 1 in that in the second example circuit, a first clock pulse generator 1 generates a first clock pulse of a frequency F1·n·m higher than a frequency F1·n, and a second clock pulse generator 2 generates a second clock pulse of a frequency F2·n·m higher than a frequency F2·n, whereas in the first example circuit, the first clock pulse generator 1 generates the first clock pulse of the frequency F1·n, and the second clock pulse generator 2 generates the second clock pulse of the frequency F2·n; and in the second example circuit, a digital divider (FD) 10 for m dividing a clock pulse is connected between an output terminal of a selector switch 3 and an input terminal of a counter 4, whereas in the first example circuit, the output terminal of the selector switch 3 and the input terminal of the counter 4 are directly connected to each other. However, there is no difference between the second example circuit and the first example circuit in terms of configurations other than the above configuration.

In the FSK signal generator according to the second embodiment, the frequency F1·n·m of the first clock pulse generated from the first clock pulse generator 1 and the frequency F2·n·m of the second clock pulse generated from the second clock pulse generator 2 are respectively made higher by m times than the frequency F1·n of the first clock pulse generated from the first clock pulse generator 1 employed in the FSK signal generator according to the first embodiment and the frequency F2 n of the second clock pulse generated from the second clock pulse generator 2 employed therein. The first clock pulse and second clock pulse of these high frequencies F1·n·m and F2·n·m are selected and outputted by the selector switch 3 switched/operated in accordance with the input data codes. However, the first clock pulse and second clock pulse selected and outputted by the selector switch 3 are m divided by the digital divider 10. The post-m-divided first clock pulse is converted into the frequency F1·n and the post-m-divided second clock pulse is converted into the frequency F2·n.

Thus, the subsequent operation of the FSK signal generator according to the second embodiment is precisely identical to the operation of the FSK signal generator according to the first embodiment. Therefore, a further explanation of the operation of the FSK signal generator according to the second embodiment is omitted.

In this case, the following specific numerical values can be employed in the FSK signal generator according to the second embodiment as specific operations. While the FSK signal generator according to the second embodiment is identical to the FSK signal generator according to the first embodiment in that the rate of input data is 1200 bps, a first frequency F1 is 1300 Hz, a second frequency F2 is 1900 Hz and an integer number n is 16, 4 is used as an integer number m in addition to the above. That is, the first clock pulse generated from the first clock pulse generator 1 is selected as 83.2 kpps (=20.8 kpps×4), and the second clock pulse generated from the second clock pulse generator 2 is selected as 121.6 kpps (=30.4 kpps×4). The frequency of the corresponding clock pulse selected and outputted by the selector switch 3 is divided into ¼ by the 4-division digital divider 10. Since the digital division to be carried out by the digital divider 10 is brought into ¼ division by thinning out the clock pulse in this case, pulse components each having a sharp waveform do not appear in such a ¼ division process, and the influence of a reduction in the number of pulses is dispersed into its back and forth sides in time. Therefore, a change in frequency spectrum of each remaining clock pulse becomes slow as a division ratio becomes large.

Thus, since the digital coded values are read from the read-only memory 5 using the clock pulse whose change in frequency spectrum is slow, in the FSK signal generator according to the second embodiment, a shift in the frequency of the FSK signal obtained by digital/analog-converting the read digital coded values also becomes slow, and hence needless spreading of the frequency spectrum can be suppressed.

### Third Preferred Embodiment

Next, FIG. 3 relates to a third embodiment of an FSK signal generator according to the present invention and is a block diagram showing its fragmentary circuit configuration. The third embodiment includes another means for suppressing the spreading of a frequency spectrum based on a conversion-point jitter produced upon conversion of an input data code.

The FSK signal generator (hereinafter called “third example circuit”) according to the third embodiment illustrated in FIG. 3 is different in configuration from the FSK signal generator (hereinafter called “second example circuit” again) according to the second embodiment illustrated in FIG. 2 in that in the third example circuit, a digital divider integral-type address counter 11 is used wherein a digital divider and a counter are formed integrally, whereas in the second example circuit, the digital divider 10 and the address counter 4 configured in several are used. However, there is no difference between the third example circuit and the second example circuit in terms of configurations other than the above configuration.

The digital divider integral-type address counter 11 employed in the FSK signal generator according to the third embodiment is perfectly identical in internal structure to the digital divider 10 and address counter 4 employed in the FSK signal generator according to the second embodiment and is merely different in use condition therefrom. The digital divider integral-type address counter 11 is advantageous in terms of a circuit scale thereof.

That is, as shown in FIG. 3, the digital divider integral-type address counter 11 is one in which an address counter section and a digital divider section are configured integrally. Both the address counter section and the digital divider section are configured by cascade-connecting ½ digital dividers. And the address counter section takes or fetches out outputs corresponding to all digits (4 bits in this case) connected in tandem upon its use, whereas the digital divider section fetches out only an output corresponding to a specific digit. The address counter section and the digital divider section are merely different from each other in terms of their use states at the fetching of their outputs. In the digital divider integral-type address counter 11, an area placed below a dotted line illustrated in FIG. 3 corresponds to a ¼ digital divider section in which the ½ digital dividers are constructed in two stages, whereas an area above the dotted line corresponds to an address scale-of-16 counter section in which the ½ digital dividers are constructed in four stages.

Since the operation of the FSK signal generator according to the third embodiment is basically identical to the operation of the FSK signal generator according to the second embodiment, a further description about the operation of the FSK signal generator according to the third embodiment is omitted.

### Fourth Preferred Embodiment

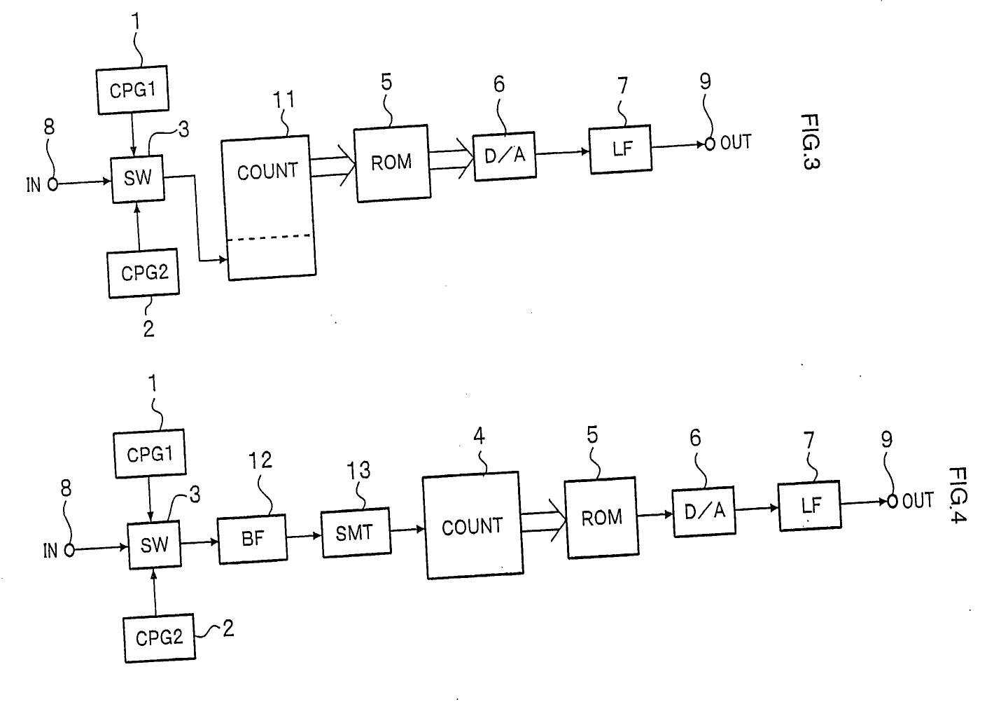

Next, FIG. 4 is a block schematic diagram showing a fourth embodiment of an FSK signal generator according to the present invention. The fourth embodiment includes a further means for suppressing the spreading of a frequency spectrum based on a conversion-point jitter produced upon conversion of each input data code.

The FSK signal generator (hereinafter called “fourth example circuit”) according to the fourth embodiment is different in configuration from the FSK signal generator (hereinafter called “first example circuit” again) according to the first embodiment in that in the fourth example circuit, a cascade connection circuit of a band-pass filter (BF) 13 and a Schmitt trigger (SMT) 14 is connected between an output terminal of a selector switch 3 and an input terminal of an address counter 4, whereas in the first example circuit, the output terminal of the selector switch 3 and the input terminal of the address counter 4 are directly connected to each other. However, there is no difference between the fourth example circuit and the first example circuit in terms of configurations other than the above configuration.

In the FSK signal generator according to the fourth embodiment, the band-pass filter 13 connected to the output terminal of the selector switch 3 selects and extracts only a necessary frequency spectrum component in a clock pulse outputted through the selector switch 3 upon switching of the selector switch 3 and suppresses extra frequency spectrum components other than it. Although the connection of the band-pass filter 13 makes it possible to extract a pulse having a frequency spectrum commensurate with a passband width of the band-pass filter 13 and suppress the amplitude of a sharp clock pulse having a frequency spectrum other than the passband width, all of the amplitude of the sharp clock pulse might not be suppressed when the frequency spectrum of the sharp clock pulse partly enters into the passband width.

Thus, the Schmitt trigger 14 is connected to the output side of the band-pass filter 13 and a hysteresis width of the Schmitt trigger 14 is made wide to some extent in the FSK signal generator according to the fourth embodiment. Consequently, the frequency spectrum of the sharp clock pulse relatively small in amplitude can be blocked.

If such a configuration is taken, then a clock pulse having a frequency change rate corresponding to the bandwidth of the band-pass filter 13 can be selected and extracted. If each digital coded value of the read-only memory 5 is read using the selected and extracted clock pulse, then the read rate of the read-only memory 5 at the frequency shift of the clock pulse can be rendered slow.

Since the operation of the FSK signal generator according to the fourth embodiment is identical to that of the FSK signal generator according to the first embodiment, a further description about the operation of the FSK signal generator according to the fourth embodiment is omitted.

Further, a combined one of the means related to the second embodiment or the means related to the third embodiment and the means related to the fourth embodiment can also be used in the FSK signal generator according to the present invention. Described specifically, the division clock pulse outputted from the digital divider 10 according to the second embodiment may be supplied to the band-pass filter 13 according to the fourth embodiment. Alternatively, the clock pulse outputted from the Schmitt trigger 14 according to the fourth embodiment can be supplied to the digital divider 10 employed in the third embodiment. If such a configuration is adopted, then a frequency spectrum out of a predetermined frequency band can be still further suppressed.

Although each of the first through fourth embodiments has explained as above by way of example, the case where as the specific numerical examples, the rate of the input data is set to 1200 bps, one shift frequency F1 of the FSK signal is set to 1300 Hz and the other shift frequency F2 thereof is set to 1900 Hz, and when the cosine waveform corresponding to one cycle is written into the read-only memory 5, the sixteen sampled values are set to the waveform of the one cycle, those using these numerical examples are merely approximate illustrations in the FSK signal generator according to the present invention. The present invention is not limited to those using the above numerical examples. It is needless to say that even though numerical examples other than the above numerical examples are used, they are similarly applicable to the FSK signal generator according to the present invention. While the preferred forms of the present invention have been described, it is to be understood that modifications will be apparent to those skilled in the art without departing from the spirit of the invention. The scope of the invention is to be determined solely by the following claims.

What is claimed is:

1. An FSK signal generator that generates an FSK signal lying in a low frequency band, which is frequency-shifted to a first frequency f1 and a second frequency f2 in response to input data codes, comprising:
a first clock generator which generates a first clock pulse having a frequency n·f1 equal to an integral n times the first frequency f1;
a second clock generator which generates a second clock pulse having a frequency n f2 equal to the integral n times the second frequency f2;
a selector switch switched by the input data codes to select and output the first clock pulse generated from the first clock generator and the second clock pulse generated from the second clock generator;
an address counter which outputs each address code according to a count of the selected and outputted clock pulse;
a read-only memory in which coded values of respective sampling points, obtained by sampling a sine waveform or a cosine waveform lying within one cycle at an n times rate are written in address order and from which each of the coded values of the respective sampling points is read in response to the address code of the address counter;
a digital/analog converter which digital/analog-converts the coded values read from the read-only memory and outputs the digital/analog-converted analog signal; and
a low-pass filter which smoothes the analog signal to form an FSK signal.

2. An FSK signal generator that generates an FSK signal lying in a low frequency band, which is frequency-shifted to a first frequency f1 and a second frequency f2 in response to input data codes, comprising:
a first clock generator which generates a first clock pulse having a frequency n m f1 equal to respective integral n and m times the first frequency f1;
a second clock generator which generates a second clock pulse having a frequency n m f2 equal to the respective integral n and m times the second frequency f2;
a selector switch switched by the input data codes to select and output the first clock pulse generated from the first clock generator and the second clock pulse generated from the second clock generator;
a digital divider which outputs m-divided clock pulses of the selected and outputted clock pulse;
an address counter which outputs address codes according to counts of the m-divided clock pulses;
a read-only memory in which coded values of respective sampling points, obtained by sampling a sine waveform or a cosine waveform lying within one cycle at an n times rate are written in address order and from which each of the coded values of the respective sampling points is read in response to the address code of the address counter;
a digital/analog converter which digital/analog-converts each coded value read from the read-only memory and outputs the digital/analog-converted analog signal; and
a low-pass filter which smoothes the analog signal to form an FSK signal.

3. An FSK signal generator that generates an FSK signal lying in a low frequency band, which is frequency-shifted to a first frequency f1 and a second frequency f2 in response to input data codes, comprising:
a first clock generator which generates a first clock pulse having a frequency n·f1 equal to an integral n times the first frequency f1;
a second clock generator which generates a second clock pulse having a frequency n·f2 equal to the integral n times the second frequency f2;
a selector switch switched by the input data codes to select and output the first clock pulse generated from the first clock generator and the second clock pulse generated from the second clock generator;
a first low-pass filter which averages a variation in the phase of the selected and outputted clock pulse;
a Schmitt trigger which waveform-shapes the clock pulse outputted from the first low-pass filter;
an address counter which outputs each address code according to a count of the waveform-shaped clock pulse;
a read-only memory in which coded values of respective sampling points, obtained by sampling a sine waveform or a cosine waveform lying within one cycle at an n times rate are written in address order and from which each of the coded values of the respective sampling points is read in response to the address code of the address counter;
a digital/analog converter which digital/analog-converts each coded value read from the read-only memory and outputs the digital/analog-converted analog signal; and
a second low-pass filter which smoothes the analog signal to form an FSK signal.

4. The FSK signal generator according to any of claims 1 to 3, wherein the read-only memory holds one cycle of the sine or cosine waveform, which has been written therein.

5. The FSK signal generator according to any of claims 1 to 3, wherein the read-only memory holds a ½ cycle of the sine or cosine waveform, which has been written therein.

6. The FSK signal generator according to any of claims 1 to 3, wherein the read-only memory holds a ¼ cycle of the sine or cosine waveform, which has been written wherein.
